(19) United States
(12) Patent Application Publication
(10) Pub. No.: US 2025/0308134 A1
(43) Pub. Date: Oct. 2, 2025

(54) DEFERRED ANY HIT SHADER EXECUTION FOR REDUCED DIVERGENCE

(71) Applicant: Advanced Micro Devices, Inc., Santa Clara, CA (US)

(72) Inventors: David Kirk McAllister, Santa Clara, CA (US); Michael John Livesley, Milton Keynes (GB); Mohammed Ahmed Muneam Al-Obaidi, Milton Keynes (GB); Mingtao Gu, Shanghai (CN); ZhongXiang Luo, Shanghai (CN); Yue Zhuo, Shanghai (CN); Zhen Hu, Shanghai (CN); LingPeng Jin, Shanghai (CN)

(73) Assignee: Advanced Micro Devices, Inc., Santa Clara, CA (US)

(21) Appl. No.: 18/620,672

(22) Filed: Mar. 28, 2024

(51) Int. Cl. G06T 15/06; G06T 15/00; G06T 17/00

(52) U.S. Cl. CPC G06T 15/06; G06T 15/005; G06T 17/005; G06T 2210/21

(57) ABSTRACT

Techniques for reducing SIMD divergence for ray tracing are provided. In ray tracing on a SIMD architecture, rays are cast into a scene. Part of such operations includes evaluating a ray cast for intersection with a triangle, which is performed using an acceleration structure. SIMD execution is performed for multiple work-items (e.g., rays) in parallel, but control flow can become divergent if the work-items need to perform different operations. During traversal, it is possible that rays require execution of an any hit shader to evaluate a candidate hit as accepted or rejected. However, if such execution is performed immediately upon detection of a candidate hit, a high degree of control flow divergence can occur, since it is likely that such execution occurs only for a single ray. By deferring this execution, it is possible to group the execution of an any hit shader for multiple work-items together, thereby reducing divergence.

### BACKGROUND

In image synthesis, ray tracing is utilized to find a nearest intersection of a given ray with a scene where light propagation is simulated. Advances in ray tracing are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates elements that perform operations for traversing the BVH, according to an example;

FIG. 6 illustrates an example technique for traversing a BVH and executing any hit shaders;

FIG. 7 illustrates a technique for combatting the inefficiency associated with immediately executing an any hit shader for an intersection with a non-opaque triangle, according to an example;

FIG. 8 illustrates an example of operations for deferring execution of any hit shaders, according to an example;

FIG. 9 illustrates an example operation for discarding an any hit shader context from a context memory in response to a subsequent confirmed intersection (hit); and

FIG. 10 is a flow diagram of a method for performing ray tracing, according to an example.

### DETAILED DESCRIPTION

Techniques for reducing single instruction multiple data (“SIMD”) divergence for ray tracing are provided. In ray tracing on a SIMD architecture such as a graphics processing unit, rays are cast into a scene in order to perform rendering operations such as determining colors for an image, testing for whether an object is between a particular 3D location and a light source, what a closest hit point from a ray origin and direction is in the scene, or to compute reflections or global illumination. Part of such operations includes evaluating a ray cast for intersection with primitives of the scene, which is performed using an acceleration structure such as a bounding volume hierarchy. SIMD execution is performed for multiple work-items (e.g., rays) in parallel, but control flow can become divergent if the work-items need to perform different operations. During traversal, it is possible that rays require execution of an any hit shader to evaluate a candidate hit as accepted or rejected as an actual hit. However, if such execution is performed immediately upon detection of a candidate hit, a high degree of control flow divergence can occur, since it is likely that such execution occurs only for a single ray. By deferring this execution, it is possible to group the execution of an any hit shader for multiple work-items together, thereby reducing divergence.

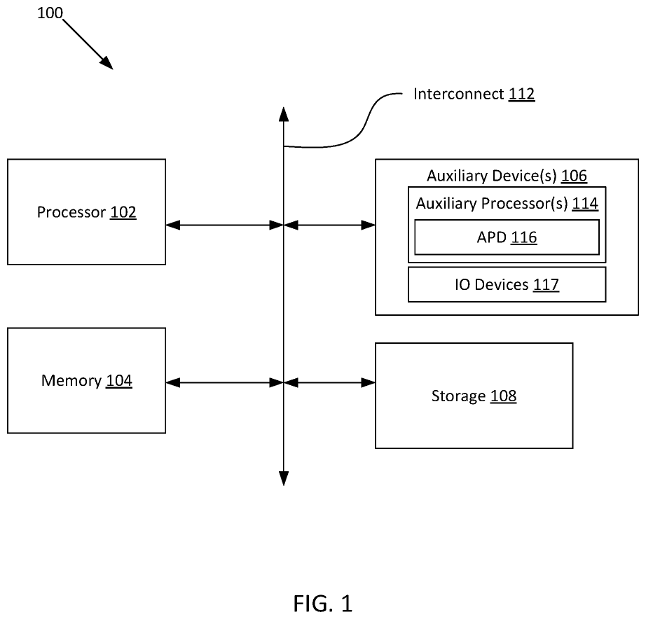

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

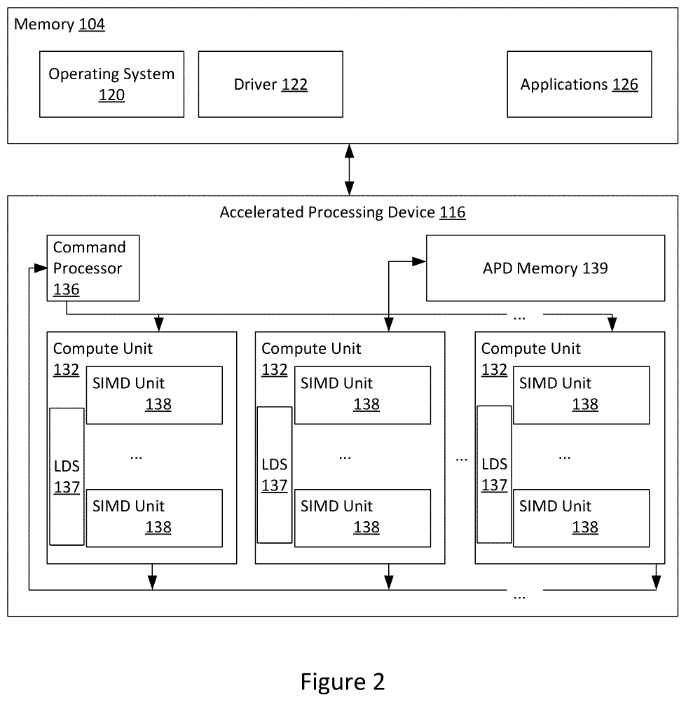

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some examples, the driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image based on commands received from the processor 102. The APD 116 also executes compute processing operations that are not directly related to graphics operations, such as operations related to video, physics simulations, computational fluid dynamics, or other tasks, based on commands received from the processor 102. In some examples, the APD 116 does not perform graphics operations.

The APD 116 includes compute units 132 that include one or more SIMD units 138 that perform operations at the request of the processor 102 in a parallel manner according to a SIMD paradigm. The compute units 132 are sometimes referred to as “parallel processing units” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

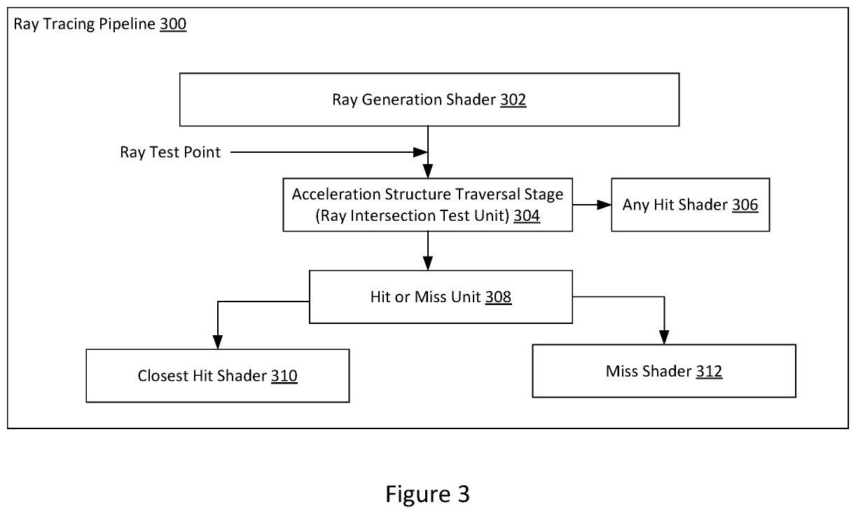

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

Any portion of the ray tracing pipeline 300 is implemented as software, hardware (e.g., circuitry such as a programmable or non-programmable processor, of fixed function circuitry) or a combination thereof, and can be implemented partially or fully on the APD 116. In various such examples, the software executes on the SIMD units 138 and/or on a different processor. More specifically, the various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle or procedural primitive and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. Another use is to spawn additional rays for reflections and/or global illumination effects. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

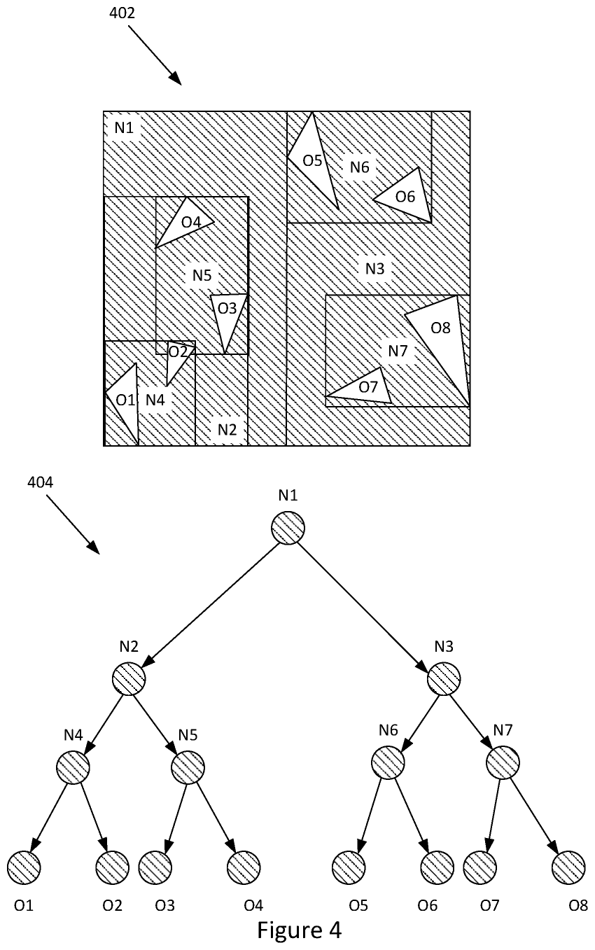

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

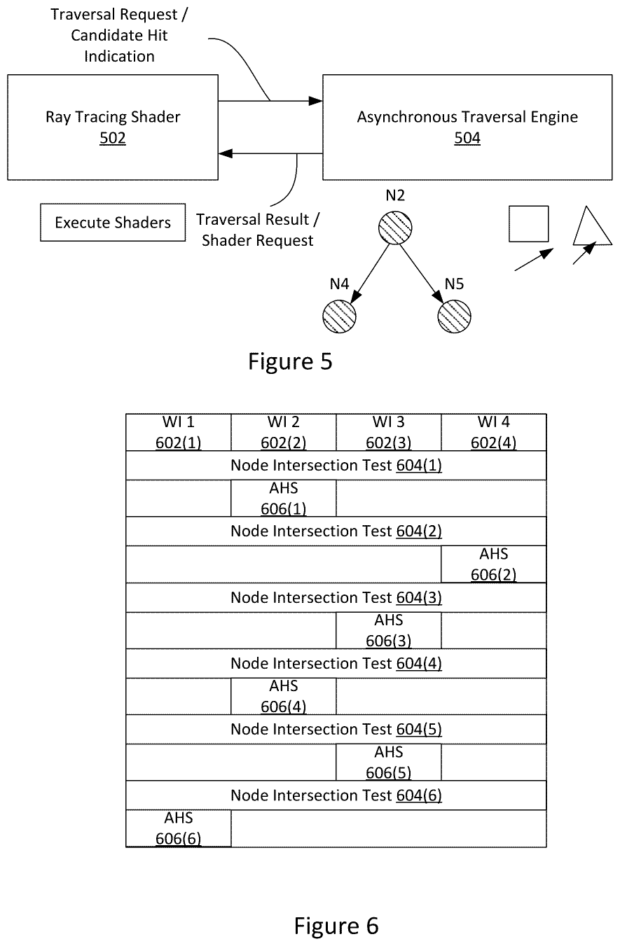

As described elsewhere herein, evaluating a ray involves traversing a bounding volume hierarchy with the ray and executing shaders as appropriate. FIG. 5 illustrates elements that perform operations for traversing the BVH, according to an example. More specifically, FIG. 5 illustrates a ray tracing shader 502 and an asynchronous intersection engine 504. The ray tracing shader 502 is a shader program that executes on the compute units 132. The ray tracing shader 502 facilitates evaluation of a ray against a BVH by instructing the asynchronous intersection engine 504 to traverse the BVH for a ray, as well as triggering execution of shaders such as closest hit shaders, traversal shaders, procedural shaders, miss shaders, and any hit shaders. The asynchronous traversal engine 504 traverses the BVH, determines whether rays intersect box nodes or triangle nodes, and, when necessary, sends requests back to the ray tracing shader 502 to have the ray tracing shader 502 execute shaders. One example of a request to execute a shader is a request to execute an any hit shader. Specifically, in some modes of operation, such as where triangles are non-opaque, traversal through the BVH includes executing an any hit shader to determine whether a candidate intersection with a triangle is actually an intersection. More specifically, the asynchronous traversal engine 504 is capable of determining, for non-opaque geometry, that a ray intersects with a triangle for a leaf node. However, it is possible that an any hit shader, executed when such an intersection determination for a triangle is made, determines that such an intersection (a “candidate intersection”) should actually be rejected as a true intersection with the triangle. As the any hit shader is specified programmatically, such a shader could make a determination as to whether to accept or reject a candidate hit in any technically feasible manner. An example is use of stencil operations to define the outline of a primitive in a very fine-grained manner. More specifically, in such an example, a stencil mask defines portions of a triangle that are opaque and portions that are not opaque. In such an example, the any hit shader evaluates the stencil mask and determines whether the candidate intersection is at a point in the mask that is opaque. If the candidate intersection is at an opaque location, then the any hit shader confirms the candidate hit to the asynchronous traversal engine 504 and if the candidate intersection is at a non-opaque location, then the any hit shader indicates that the candidate hit is not a hit.

One example as to how the asynchronous traversal engine 504 uses the information about whether a candidate hit is accepted includes using that information for the purpose of determining which hit is a closest hit. More specifically, a closest hit is the intersection of the ray with a leaf node that is the closest to the origin of the ray.

The asynchronous traversal engine 504 performs the operations of traversing the BVH and of evaluating the ray against the nodes (e.g., box nodes and triangles) of the BVH. In an example, the ray tracing shader 502 provides a ray to the asynchronous traversal engine 504 and the asynchronous traversal engine 504 evaluates the ray using the BVH. In the course of this evaluation, when the asynchronous traversal engine 504 arrives at a non-leaf node, the asynchronous traversal engine 504 tests the ray for intersection with the bounding volume of the non-leaf node. If the asynchronous traversal engine 504 determines that an intersection occurs, then the asynchronous traversal engine 504 continues on to the children of that non-leaf node and if the asynchronous traversal engine 504 determines that an intersection does not occur, then the asynchronous traversal engine 504 eliminates the children of that node from consideration. For a leaf node, the asynchronous traversal engine 504 tests the ray for intersection against the geometry of the leaf node and performs operations accordingly. Such operations vary based on the result of the test and other factors. In various situations, the asynchronous traversal engine 504 triggers execution of one or more shaders, by the ray tracing shader 502, based on the results of the intersection test. Some examples follow.

In one example, described in more detail elsewhere herein, the asynchronous traversal engine 504 requests the ray tracing shader 502 to execute an any hit shader upon determining that the ray intersects geometry of a leaf node. Among other things, in some examples, the any hit shader evaluates whether a candidate hit is accepted as an actual hit or not. In another example, when the asynchronous traversal engine 504 has identified the accepted hit that is the closest to the origin of the ray, the asynchronous traversal engine 504 requests the ray tracing shader 502 to execute a closest hit shader, which can perform any technically feasible operation such as determining a color for the pixel associated with the ray. In some examples, the asynchronous traversal engine 504 arrives at a procedural node and requests the ray tracing shader 502 to perform the corresponding intersection shader. An intersection shader is a shader that determines whether a ray intersects geometry of a leaf node. An intersection shader differs from the any hit shader in that, when the asynchronous traversal engine 504 arrives at a intersection shader node, the asynchronous traversal engine 504 does not perform an intersection test with the underlying geometry to possibly obtain a candidate hit. Instead of participating with the ray tracing shader 502 executing an any hit shader to determine whether a hit occurs, the decision of whether a hit occurs for a procedural node is left to the intersection shader. Intersection shaders are useful for defining leaf node geometry other than that of a triangle. For any of these cases, the asynchronous traversal engine 504 requests the ray tracing shader 502 to execute the desired shader.

In some examples, one or more operations of the ray tracing shader 502 or asynchronous traversal engine 504 are implemented as any combination of programmable operations of software executing on a processor, or as operations performed by a different type of circuit such as a fixed function circuit or processor.

There are potential inefficiencies in the above-described operations for evaluating a ray using a BVH. More specifically, one possible mode of execution for the asynchronous traversal engine 504 is one in which the asynchronous traversal engine 504 traverses a BVH, testing non-leaf nodes and leaf nodes for intersection as described elsewhere herein until a non-leaf node whose intersection test triggers an any hit shader (e.g., when a candidate hit is identified). Then, the asynchronous traversal engine pauses traversal of the BVH and requests the ray tracing shader 502 to execute the any hit shader. Once the any hit shader executes, the asynchronous traversal engine 504 continues traversal of the BVH.

FIG. 6 illustrates an example technique for traversing a BVH and executing any hit shaders. FIG. 6 illustrates single instruction multiple data (“SIMD”) based BVH traversal. In SIMD based BVH traversal, a plurality of work-items 602 process different rays in parallel. The different rays do not have to be related in any way, though often rays that execute together are all involved with generating a single (e.g., the same) particular output image (e.g., a final image for a render target or an intermediate image used in a multi-pass rendering).

As described elsewhere herein, in SIMD execution, multiple work-items 602 execute in parallel but may diverge where the multiple work-items perform different operations. For the purposes of SIMD execution, the asynchronous traversal engine 504 is constructed in a way that multiple different BVH-operations can occur in parallel. For example, it is possible for the asynchronous traversal engine 504 to perform an intersection test testing a bounding volume against a ray for one work-item 602 while at the same time, performing an intersection test testing a triangle against a ray for a different work-item 602. Thus, while the asynchronous intersection engine 504 is traversing the BVH, the work-items 602 operating together (e.g., as part of a wavefront) do not experience divergence. However, when the asynchronous traversal engine 504 determines that an any hit shader is to be executed, and the asynchronous traversal engine 504 thus causes the ray tracing shader 502 to execute the any hit shader, divergence often occurs. More specifically, because it is frequently the case that only one work-item out of all work-items of a wavefront requires an any hit shader to be executed at any given point in time, only one work-item will execute the any hit shader, with the remaining work-items remaining stalled. Once the work-item completes the any hit shader and returns the result to the asynchronous traversal engine 504, the asynchronous traversal engine 504 continues to traverse the BVH.

FIG. 6 illustrates an example of this mode of execution. Specifically, in FIG. 6, four work-items 602 are traversing a BVH for different rays. Although only four work-items 602 are illustrated, it should be understood that this number is exemplary and used for illustrative purposes and that wavefronts can have a different (e.g., larger) size. In FIG. 6, time progresses to the right. Operations for the different work-items are stacked vertically. More specifically, in FIG. 6, items shown to the right are later in time than items shown to the left. Moreover, operations for the same work-item occupy the same row of FIG. 6. These rows are stacked upon each other (stacked vertically) with the operations of each row corresponding to a different work-item.

In FIG. 6, work-items 602(1)-602(4) are traversing a BVH for respective rays in lockstep. In the first operation shown, the asynchronous traversal engine 504 performs node intersection test 604(1), testing one or more rays against the BVH for each work-item 602. This operation determines that work-item 2 602(2) should execute an any hit shader 606(1). Thus, the asynchronous traversal engine 504 pauses execution and causes the ray tracing shader 502 to execute an any hit shader 606(1) for work-item 2 602(2). When that is complete, the asynchronous traversal engine 504 performs node intersection test 604(2), and then causes the ray tracing shader 502 to execute any hit shader 606(2) for work-item 4 602(4). Then, the asynchronous traversal engine 504 performs node intersection test 604(3) and causes the ray tracing shader 502 to execute any hit shader 606(3) for work-item 3 602(3), performs node intersection test 604(4) and causes the ray tracing shader 502 to perform any hit shader 606(4) for work-item 2 602(2), performs node intersection test 604(5) and causes the ray tracing shader 502 to execute any hit shader 606(5) for work-item 3 602(3), performs node intersection test 604(6), and causes the ray tracing shader 502 to execute any hit shader 606(6) for work-item 1 602(1). As can be seen, a great deal of divergence occurs, as each time the any hit shader 606 is executed for a work-item 602, no work is performed for any other work item. This represents an inefficiency.

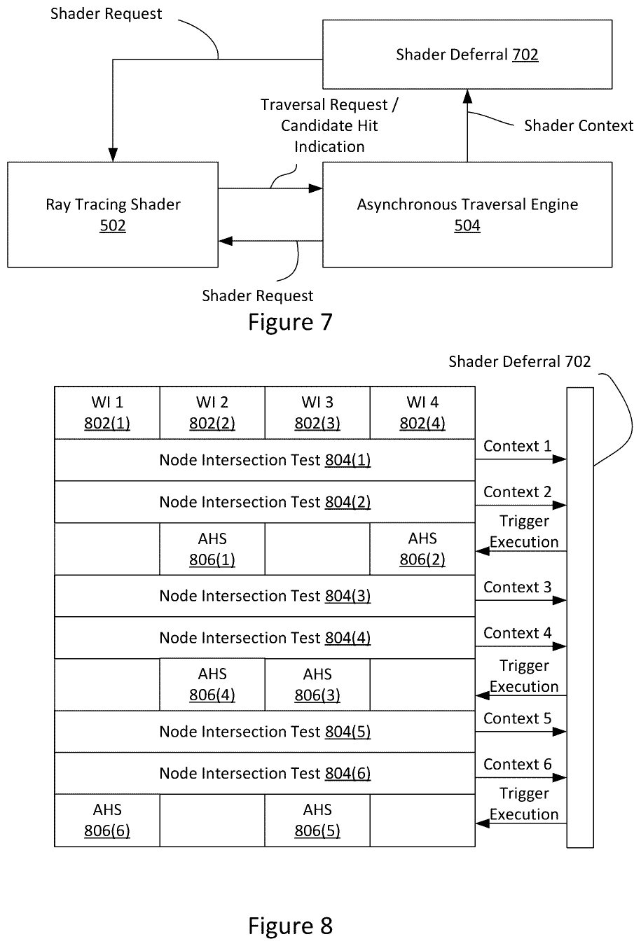

FIG. 7 illustrates a technique for combatting the inefficiency associated with immediately executing an any hit shader for an intersection with a non-opaque triangle, according to an example. The elements of FIG. 7 include a ray tracing shader 502 and an asynchronous traversal engine 504, as in FIG. 5, but also include shader deferral 702. Shader deferral 702 is implemented, in various examples, in any technically feasible manner, such as via software executing on a processor, a fixed function processor, fixed function circuitry, or via any other combination of software and hardware (e.g., circuitry). In some examples, the shader deferral 702 represents operations of the asynchronous traversal engine 504.

The shader deferral 702 defers execution of an any hit shader to a future point, which increases the likelihood that such an any hit shader is executed together with a another any hit shader, decreasing divergence. In response to determining that an any hit shader should be executed, the asynchronous traversal engine 504 transmits a shader context to shader deferral 702. The shader context includes information derived from the result of the intersection test against a non-leaf node (e.g., triangle), and indicates one or more of a time value indicating the time of intersection, a hit kind indicating whether the intersection is a back face or front face hit, an address of the data for the triangle hit, an identifier for the triangle, an identifier for the geometry associated with the triangle, an identifier for the any hit shader to be executed, and a hit group record index. The time value indicates the distance from the origin of the ray to the point of intersection. The address of the data for the triangle hit includes an address at which data for the triangle that is hit can be found. Non-limiting examples of such data includes vertex information, texture coordinates, or other information. The identifier for the triangle is an identifier that uniquely identifies which triangle is hit. The identifier for the geometry is an identifier that uniquely identifies larger geometry (e.g., a mesh) that the triangle is a part of. The hit group record index is an index into a table that indicates what shader to run and what resources to use to run that shader.

The shader deferral 702 instructs the ray tracing shader 502 to perform an any hit shader upon determining that a deferred shader execution trigger has occurred. A variety of deferred shader execution triggers are possible, and the present disclosure contemplates implementations of shader deferral 702 that implement any combination of such deferred shader execution triggers.

One example of a deferred shader execution trigger is that the ray tracing shader 502 receives a shader context for a work-item while storing a maximum number of shader contexts for that work-item. More specifically, as described, when the asynchronous traversal engine 504 determines that an any hit shader should be executed for a particular work-item, if the shader deferral 702 already stores a maximum number of shader contexts for that work-item, the shader deferral 702 causes the ray tracing shader 502 to execute any hit shaders based on one or more shader contexts. In some examples, the maximum number is one, so that if the shader deferral 702 stores one shader context for a work-item and then receives another shader context for the work- item, the shader deferral 702 causes an any hit shader to execute for at least the stored shader context. In such instance, shader deferral 702 stores the incoming shader context for execution at a later time. Another example of a deferred shader execution trigger is that shader deferral 702 stores at least a threshold number of shader contexts for different work-items that all target the same any hit shader. In such a situation, it is possible to execute multiple any hit shaders in parallel by the ray tracing shader 502. Other example ways in which the shader deferral 702 causes an any hit shader to execute include the following. One such example way includes a watchdog timer for a set number of cycles that starts when there is at least one any hit shader ready to execute for at least one work-item, and runs to a pre-determined amount of time. When the timer reaches the pre-determined amount of time, the shader deferral 702 causes at least that waiting any hit shader to execute. Another example way is that if the number of work-items that are still actively traversing the BVH is below a threshold percent, then at least one any hit shader is triggered to execute.

In response to a deferred shader execution trigger, the shader deferral attempts to group together any hit shader contexts for execution by the ray tracing shader 502 in order to reduce divergence. More specifically, in some examples or situations, the shader deferral 702 identifies shader contexts that are to execute the same any hit shader and causes the ray tracing shader 502 to execute such identified shader contexts in parallel. It is possible, for example, for a particular leaf node to specify execution of a first any hit shader when a candidate hit for that leaf node is detected, and for a different leaf node to specify execution of a second any hit shader when a candidate hit for that leaf node is detected. In other words, it is possible for candidate hits for different leaf nodes to specify different any hit shaders to execute. The shader context includes an indication of which any hit shader is to execute (e.g., which any hit shader code-that is, which any hit shader program is to execute). The ray tracing shader 502 executes any hit shaders together for different work-items for shader contexts that specify the same any hit shader. Executing the same any hit shader for different work items together helps to reduce divergence.

FIG. 8 illustrates an example of operations for deferring execution of any hit shaders, according to an example. FIG. 8 depicts work-items 802 which are similar to work-items 602 of FIG. 6, as well as node intersection tests 804 and any hit shader executions 806.

In operation, the asynchronous traversal engine 504 performs node intersection test 804(1), which determines that geometry of a leaf node for work-item 2 802(2) triggers an any hit execution. The asynchronous traversal engine 504 provides the shader context for that any hit execution to the shader deferral 702, instead of causing the ray tracing shader 502 to execute that any hit shader immediately. The asynchronous traversal engine 504 also performs node intersection test 804(2), which determines that geometry of a leaf node for work-item 4 802(4) triggers an any hit execution, and provides context 2 to shader deferral 702. As part of the node intersection test 804(2), a deferred shader execution trigger occurs, and thus shader deferral 702 causes the ray tracing shader 502 to execute any hit shader 806(1) and any hit shader 806(2) based on context 1 and context 2. Subsequently, similar operations occur, with the asynchronous traversal engine 504 performing node intersection test 804(3) and intersection test 804(4), resulting in context 3 and context 4 being transmitted to shader deferral 702 for work-item 3 802(3) and work-item 2 802(2), respectively, and subsequent execution of any hit shader 806(3) and 806(4) together, based on the contexts and in response to a deferred shader execution trigger. Similar operations occur for node intersection test 804(5) and node intersection test 804(6), resulting in execution of any hit shader 806(5) and any hit shader 806(6) together.

As can be seen, the deferral of any hit shaders execution for a period of time allows accumulation of such executions for execution together where possible (e.g., when the same any hit shader is to be executed for different rays/work-items). This in turn results in a shorter total execution time as the amount of divergence that occurs during any hit shader execution is reduced where multiple work-items 802 perform such execution in parallel.

It should be noted that storing the any hit shader contexts allow the asynchronous traversal engine 504 to continue traversal of a ray after a candidate hit has been found for that ray. This possibility allows for overlapping of onward traversal of the BVH with buffering the candidate hit (i.e., storage of the any hit shader context) and execution of the any hit shader itself. These features also allow for the possibility of culling the shader context before running an any hit shader for that context. Overlapping onward traversal of the BVH with execution of the any hit shader allows for culling an accepted hit after the any hit shader is executed if it subsequently discovered through traversal of the BVH that the confirmed candidate hit is behind a different opaque object.

In addition to reducing divergence by deferring execution and subsequently grouping together any hit shader contexts, the shader deferral 702 also is able to cull shader contexts in response to a shader context cull trigger. In some examples, an opaque triangle hit that is closer to the origin of the ray eliminates the possibility that any other triangle farther from the origin will be a closest hit. In this situation, where any hit shaders are not otherwise needed, an any hit shader for a farther hit from the origin of the ray would not matter once it is determined that a hit occurred closer to the origin. Thus, in some situations, shader deferral 702 culls any hit shader contexts in the event that a confirmed hit occurs for a closer primitive.

More specifically, as described elsewhere herein, a shader context stores a time to intersection. This time to intersection represents the distance from the origin of the ray to the intersection point. When a confirmed hit occurs at a time to intersection that is closer to the origin than that for any stored shader context, the shader deferral 702 discards the shader contexts for candidate hits that are farther from the origin than the confirmed hit. In various examples, the confirmed hit occurs either as a result of the asynchronous traversal engine 504 determining that a hit occurs for opaque geometry or as a result of an any hit shader confirming a candidate hit for non-opaque geometry. In some examples, the above culling is disabled to meet an application programming interface determinism requirement. Specifically, in some situations, an application programming interface determinism requirement requires that shaders are executed in a deterministic order. In this case, it is not possible to cull shader executions. Thus, in the situation where a switch to turn such function off is enabled, such culling does not occur.

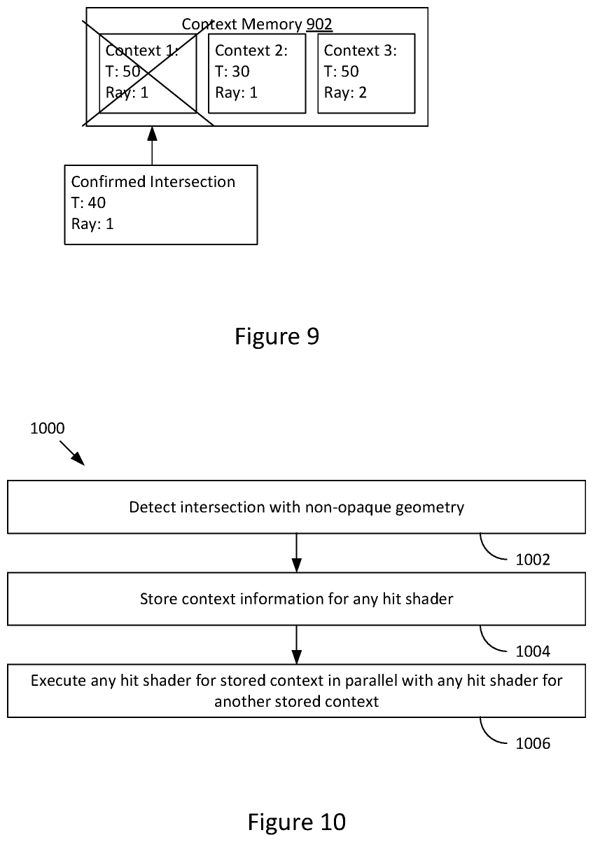

FIG. 9 illustrates an example operation for discarding an any hit shader context from a context memory 902 in response to a subsequent confirmed intersection (hit). The context memory 902 represents any memory within the APD 116 (e.g., LDS 137 or APD memory 139 or registers in the compute units 132) or in a different location, and is the location to which the asynchronous traversal engine 504 writes the shader contexts. As stated elsewhere herein, when a confirmed hit occurs for a particular ray, and the time to intersection (distance from origin of ray to intersection) is less than the time to intersection of a stored context for the same ray, the shader deferral 702 removes the stored context from the context memory 902. This removal prevents an any hit shader for the context from being executed. Such an any hit shader is not needed in the illustrated situation, because a confirmed intersection has occurred for a shorter distance than the distance for the context.

In FIG. 9, context 1 resides in context memory 902. Context 1 is for ray 1 and specifies that intersection occurs at distance t=50. While the context is in context memory 902, a confirmed intersection occurs for ray 1 with distance t=40. This confirmed intersection is either a hit detected by the asynchronous traversal engine 504 for an opaque triangle or is a candidate hit which was confirmed by its own any hit shader. Regarding context 2, this context is not discarded because this context is, itself, closer to the origin of the ray than the confirmed intersection. Regarding context 3, this context is for a different ray and thus is not discarded.

It should be understood that not all modes of operation are modes in which a confirmed intersection closer than a candidate intersection means that the candidate intersection should be eliminated. However, in modes of operation in which such candidate intersection should be eliminated, operations for such elimination (as described elsewhere herein) are performed. In some examples, it is desirable to execute an any hit shader for all hits for a ray against leaf node geometry, in which case any hit shader contexts are not discarded as described in FIG. 9 and elsewhere herein.

FIG. 10 is a flow diagram of a method 1000 for performing ray tracing, according to an example. Although described with respect to the system of FIGS. 1-9, those of skill in the art will recognize that any system configured to perform the steps of the method 1000 in any technically feasible order falls within the scope of the present disclosure.

At step 1002, an asynchronous traversal engine 504 detects intersection of a ray with non-opaque leaf node geometry. Intersection with non-opaque geometry indicates that an any hit shader is to be executed in order to determine whether to accept or reject that intersection. There are a variety of reasons why a candidate hit on non-opaque geometry needs additional confirmation of an actual hit, and an any hit shader can define any particular technique for such confirmation. In a non-limiting example, stencil data is used to define the outline of a shape that only roughly corresponds to a triangle. In such an example, intersection with the triangle requires further consideration by an any hit shader which tests the location of the intersection against the stencil data to determine whether the geometry corresponding to the stencil data is opaque or non-opaque at that point. Although this particular technique is described, any technique can alternatively be used.

At step 1004, shader deferral 702 stores a shader context for the candidate hit in a context memory 902. The shader context includes sufficient information to execute the appropriate any hit shader at a later time. In various examples, such information includes any or all of a time value indicating the time of intersection, a hit kind indicating whether the intersection is a back face or front face hit, an address of the data for the triangle hit, an identifier for the triangle, an identifier for the geometry associated with the triangle, an identifier for the any hit shader to be executed, and a hit group record index, described elsewhere herein.

At step 1006, the ray tracing shader 502 executes two or more any hit shaders for which contexts are stored in the context memory 902 together in parallel. As described elsewhere herein, by grouping together the contexts to execute the any hit shaders in parallel, divergence is reduced. The any hit shaders that are grouped together to execute are for different rays but are the same any hit shader-that is, the same code. This way, multiple work-items 602 can execute this any hit shader in parallel.

It is possible to repeat the steps of FIG. 10 any number of times while traversing a BVH. Shader deferral 702 monitors the state of the stored contexts, monitors for deferred shader execution triggers, and launches the any hit shaders as appropriate. The asynchronous traversal engine 504, where appropriate, transmits a shader context to shader deferral and then continues traversal of the BVH without pausing for execution of the any hit shader. The asynchronous traversal engine 504 is able to traverse the BVH concurrently with the ray tracing shader performing operations such as executing an any hit shader. Traversal of the BVH may pause if there is no more context space or if all BVH traversal work is waiting on some information to be determined. As described with respect to FIG. 9, shader deferral 702 may modify the contents of the context memory 902 based on operations such as detecting that a confirmed hit occurs for a ray, where the context memory 902 stores at least one context for that ray and the time to intersection for the stored context is greater than the time to intersection of the confirmed hit.

It is sometimes stated herein that the ray tracing shader 502 executes an any hit shader. Such a statement should be taken to mean that the ray tracing shader 502 causes the execution of an any hit shader to occur, for example, by branching to the address of the any hit shader and continuing execution at that point.

It should be noted that although it is stated herein that the shaders for which the contexts are stored (and thus the shaders that are deferred) are any hit shaders, it is also possible to perform such operations for intersection shaders. Thus, any disclosure herein that applies to any hit shaders also applies to intersection shaders, except that in some examples, culling based on intersection distance is different. More specifically, it is possible to store the “time to enter” (the distance from ray origin at which the ray enters a bounding volume) for a bounding volume (e.g., a bounding volume stored in a node of the BVH) that bounds the geometry of the intersection shader. If the intersection shader is for a non-opaque node and it is determined that the ray intersects a primitive closer to this time to enter, then this means that it is not necessary to execute the intersection shader to determine whether a hit occurs, as the closer confirmed hit will render evaluation of the intersection shader moot. In this instance, the context for the intersection shader is culled.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the accelerated processing device 116, the scheduler 136, the compute units 132, the SIMD units 138,, local data store 137, APD memory 139, ray tracing pipeline 300, ray generation shader 302, acceleration structure traversal stage 304, any hit shader 306, hit or miss unit 308, closest hit shader 310, miss shader 312, ray tracing shader 502, asynchronous traversal engine, shader deferral 702, or context memory 902 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing ray tracing operations, the method comprising:
storing a first shader context for a first ray associated with a first candidate hit;
continuing traversal of a bounding volume hierarchy (“BVH”) without executing a shader for the first candidate hit; and
in response to a first deferred shader execution trigger, executing a first shader based on the first shader context.

2. The method of claim 1, wherein the first shader is executed in parallel with a second shader associated with a second shader context, and the first shader context and the second shader context are for different rays.

3. The method of claim 1, wherein the first shader context stores an indication of which shader to execute.

4. The method of claim 2, wherein the first shader context and the second shader context specify the same shader for different rays.

5. The method of claim 1, wherein the first candidate hit comprises a hit detected for non-opaque geometry.

6. The method of claim 1, further comprising:
culling a second shader context based on a confirmed hit.

7. The method of claim 6, wherein the confirmed hit has a time to intersection that is shorter than the time to intersection of the second shader context.

8. The method of claim 1, further comprising continuing traversal of the BVH for the first ray while executing an any hit shader.

9. The method of claim 1, further comprising adhering to an application programming interface determinism requirement based on a configuration switch.

10. A device for performing ray tracing operations, the device comprising:
a memory; and
a processor configured to:
store a first shader context for a first ray associated with a first candidate hit;
continue traversal of a bounding volume hierarchy (“BVH”) without executing a shader for the first candidate hit; and
in response to a first deferred shader execution trigger, execute a first shader based on the first shader context.

11. The device of claim 10, wherein the first shader is executed in parallel with a second shader associated with a second shader context, and the first shader context and the second shader context are for different rays.

12. The device of claim 10, wherein the first shader context stores an indication of which shader to execute.

13. The device of claim 11, wherein the first shader context and the second shader context specify the same shader for different rays.

14. The device of claim 10, wherein the first candidate hit comprises a hit detected for non-opaque geometry.

15. The device of claim 10, wherein the processor is further configured to:
cull a second shader context based on a confirmed hit.

16. The device of claim 15, wherein the confirmed hit has a time to intersection that is shorter than the time to intersection of the second shader context.

17. The device of claim 10, wherein the processor is further configured to continue traversal of the BVH for the first ray while executing an any hit shader.

18. The device of claim 10, wherein the processor is further configured to adhere to an application programming interface determinism requirement based on a configuration switch.

19. A non-transitory computer-readable medium storing instructions that, when executed by a processor, cause the processor to perform operations comprising:
storing a first shader context for a first ray associated with a first candidate hit;
continuing traversal of a bounding volume hierarchy (“BVH”) without executing a shader for the first candidate hit; and
in response to a first deferred shader execution trigger, executing a first shader based on the first shader context.

20. The non-transitory computer-readable medium of claim 19, wherein the first shader is executed in parallel with a second shader associated with a second shader context, and the first shader context and the second shader context are for different rays.
